(19) United States
(12) Patent Application Publication
(10) Pub. No.: US 2012/0177942 A1
(43) Pub. Date: Jul. 12, 2012

(54) COMPOSITE STRUCTURE AND METHOD FOR MAKING THE SAME

(75) Inventors: Chia-Ming CHANG, Taichung City (TW); Shih-Chang YEH, Taichung City (TW); Chung-Ho LIU, Taichung City (TW); Sheng-Hung YI, Taichung City (TW)

(73) Assignee: TAIWAN GREEN POINT ENTERPRISES CO., LTD., Taichung City (TW)

(21) Appl. No.: 13/344,796

(22) Filed: Jan. 6, 2012

Related U.S. Application Data
(60) Provisional application No. 61/430,554, filed on Jan. 7, 2011.

(51) Int. Cl. B32B 5/18; B05D 5/00; B05D 3/02

(52) U.S. Cl. 428/613; 427/556

(57) ABSTRACT

A composite structure for an electronic device includes: a metallic base part made from a metallic material and having at least one bonding region; at least one porous protrusion made from a sintered metal powder and bonded to and protruding from the bonding region; and at least one feature molded over the porous protrusion.

### CROSS-REFERENCE TO RELATED APPLICATION

This application claims priority of United States Provisional Patent Application No. 61/430554, filed on Jan. 7, 2011.

### BACKGROUND OF THE INVENTION

1. Field of the Invention

The invention relates to a composite structure and a method for making the same, and more particularly to a composite structure having a metallic base part and a molded feature formed over the metallic base part with an interlocking mechanism or a mark in between.

2. Description of the Related Art

Metallic parts often need features for decoration or for assembly. In solid-metal forming processes, e.g. stamping or forging, the material's formability is poor. Adding ribs, bosses or decoration labels with thickness variation are either not possible or not cost effective. Although liquid-metal cast can be applied to cast metal parts with complicated shape, the cosmetic and structural quality of the resulting parts are often not acceptable for the parts that often contain porosity, non-fill or flow marks. For those products that require high-quality finish and complicated shape, computerized numerical control (CNC) has been applied to remove unwanted material from a block of metal. However, the long machining cycle time and the large amount of waste materials make CNC very expensive and unfriendly to the environment. Welding can be applied to join alloy components onto a preformed metal part. However, the additional costs of those components, the cost of high-power heat source and the burn-mark make welding not competitive. Therefore, it is desirable to find a method that can form near net-shape features on a pre-formed metal part cost effectively without damaging its cosmetic surface.

### SUMMARY OF THE INVENTION

Therefore, the object of the present invention is to provide a composite structure and a method for making the same that can overcome at least one of the aforesaid drawbacks associated with the prior art.

According to one aspect of the present invention, there is provided a composite structure that comprises: a metallic base part made from a metallic material and having at least one bonding region; at least one porous protrusion made from a sintered metal powder and bonded to and protruding from the bonding region; and at least one feature molded over the porous protrusion.

According to another aspect of the present invention, there is provided a method for making a composite structure. The method comprises: preparing a metallic base part made from a metallic material and having at least one bonding region; applying a body of a metal powder on the bonding region; laser sintering the body of the metal powder on the bonding region so as to form a porous protrusion of a sintered metal powder bonded to the bonding region; and molding a moldable material over the porous protrusion on the bonding region so as to form a feature bonded to and covering the porous protrusion.

### BRIEF DESCRIPTION OF THE DRAWINGS

In drawings which illustrate embodiments of the invention,

FIG. 1 is an exploded perspective view of the preferred embodiment of an electronic device housing according to the present invention;

FIG. 2 is a sectional view taken along line II-II in FIG. 1;

FIGS. 3A to 3C are schematic views illustrating consecutive steps of the preferred embodiment of a method of making an electronic device housing according to the present invention;

FIG. 4 is a perspective view of the second preferred embodiment of a composite structure of a mechanical article according to the present invention; and

FIG. 5 is a sectional view taken along line V-V in FIG. 4.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

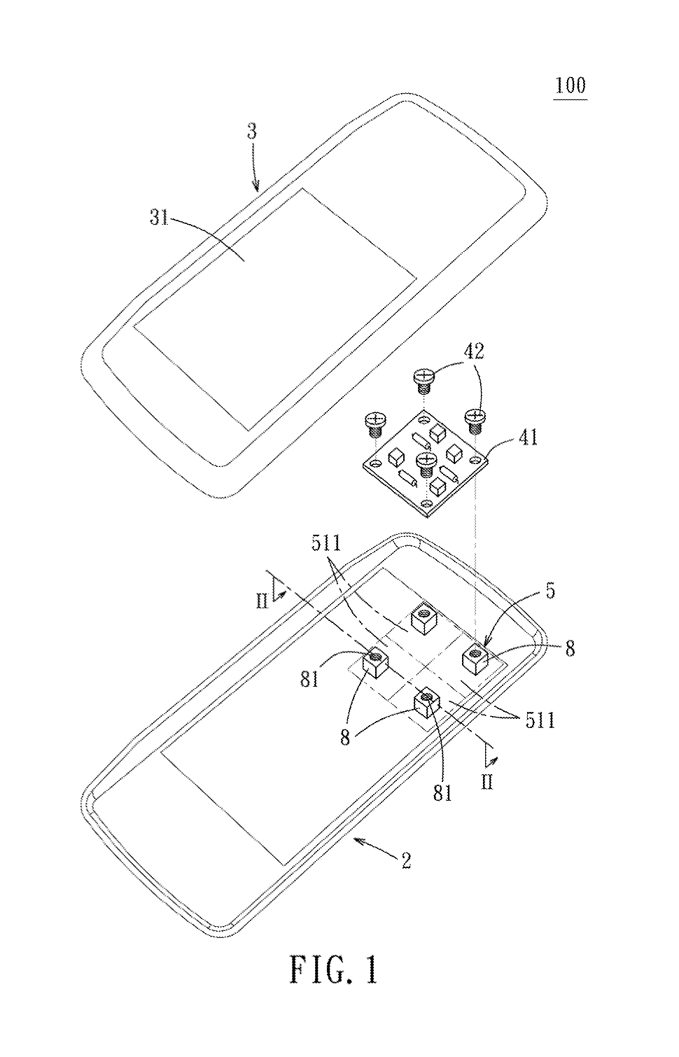

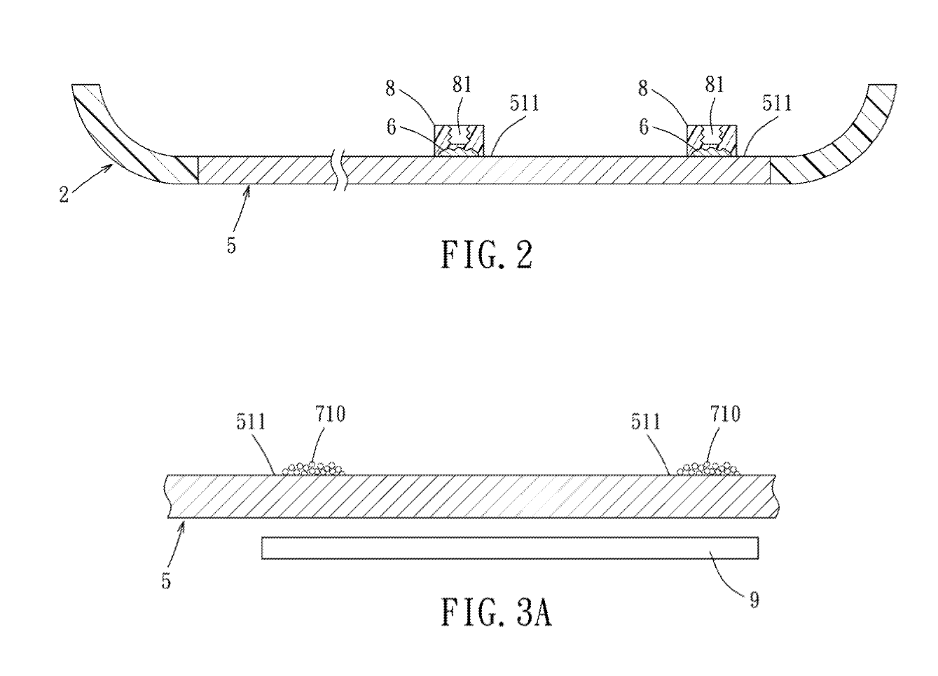

FIGS. 1 and 2 illustrate an electronic device 100, such as a mobile phone, including the preferred embodiment of a composite structure 2 of an electronic device housing according to the present invention. The electronic device 100 further includes a front cover 3 provided with a display screen 31 and coupled to the composite structure 2, and external components 41, such as a circuit board and a camera module. For the sake of brevity, only one of the external components 41, i.e., the circuit board, is illustrated in FIGS. 1 and 2 and described in the following paragraphs.

The composite structure 2 of the electronic device housing is adapted to accommodate and hold the external components 41 therein, and includes: a metallic base part 5 made from a first metallic material and having four bonding regions 511; four porous protrusions 6 made from a sintered metal powder and bonded to and protruding from the bonding regions 511, respectively; and four features 8 molded over the porous protrusions 6, respectively, and each formed with an interlocking member 81 adapted to interlock with one of the external components 41 of the electronic device 100.

The interlocking member 81 is in the form of a threaded hole formed in the corresponding feature 8 and adapted to threadedly engage a fastener 42 for fastening said one of the external components 41 of the electronic device 100 to the feature 8. Alternatively, each feature 8 can have a structure engaging said one of the external components 41 in a tongue-and-groove or press fit engaging manner instead of the threadedly engaging manner.

The first metallic material is preferably selected from aluminum, nickel, magnesium, titanium, copper, alloys thereof, and stainless steel.

The features 8 are made from a second metallic material or a plastic material selected from thermoplastics, thermosetting resin, elastomer and plastic alloy (plastic plus carbon/glass fiber). Preferably, the plastic material is selected from polycarbonate and polyacetylene. The second metallic material can be the same as or different from the first metallic material.

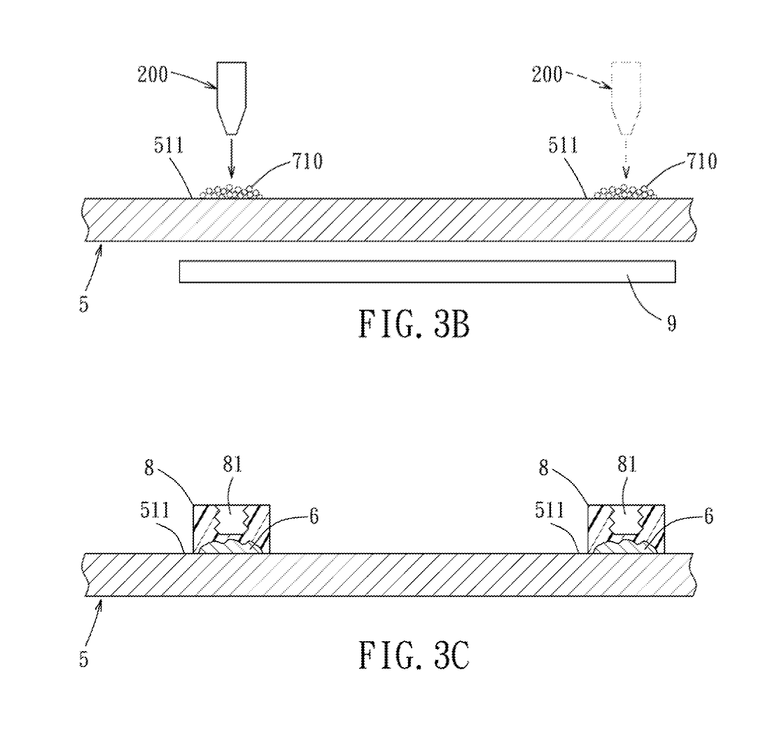

FIGS. 3A to 3C, in combination with FIGS. 1 and 2, illustrate the preferred embodiment of a method of making the composite structure 2 according to the present invention. The method includes the steps of: preparing a metallic base part 5 made from a metallic material and having at least one bonding region 511 (see FIG. 3A); applying a body of a metal powder 710 on the bonding region 511 (see FIG. 3A); magnetically fixing the body of the metal powder 710 on the bonding region 511 using a magnet 9 (see FIG. 3A) for subsequent laser sintering of the body of the metal powder 710; laser sintering the body of the metal powder 710 on the bonding region 511 using a laser device 200 (see FIG. 3B) so as to form a porous protrusion 6 of a sintered metal powder bonded to the bonding region 511; removing unsintered metal powder 710 on the bonding region 511; and molding a moldable material over the porous protrusion 6 on the bonding region 511 so as to form a feature 8 bonded to and completely covering the porous protrusion 6 (see FIG. 3C). It is noted that the molding of the moldable material can be plastic molding or die-cast molding. The moldable material can be a plastic material or a metallic material.

Preferably, the molding of the moldable material over the bonding region 511 is conducted by insertion molding so that the feature 8 thus formed can have a structure including the interlocking member 81.

Preferably, the metal powder 710 is selected from iron powder, aluminum powder, nickel powder, magnesium powder, titanium powder, copper powder, powders of alloys thereof, and stainless steel powder.

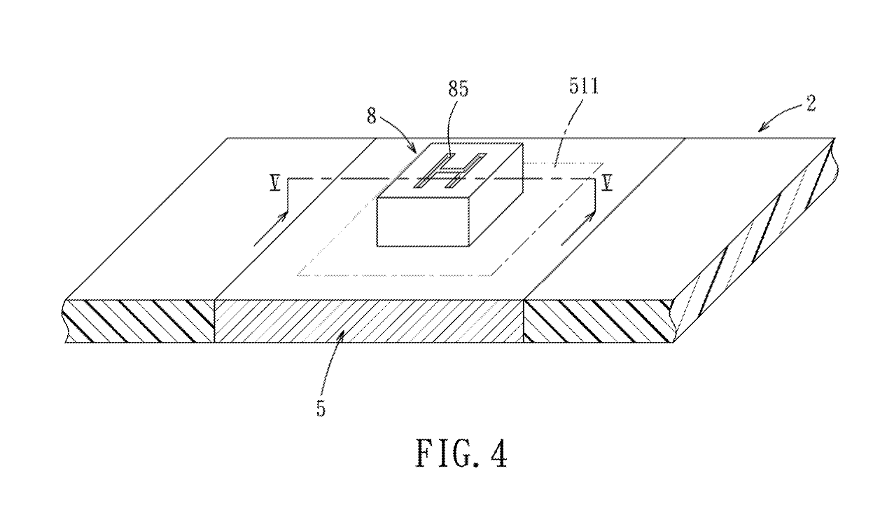

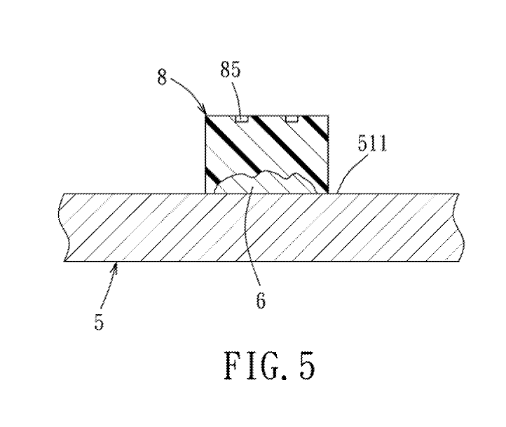

FIGS. 4 and 5 illustrate the second preferred embodiment of a composite structure 2 of a mechanical article according to the present invention. The second preferred embodiment differs from the previous embodiment in that the composite structure 2 is used for a mechanical article instead of the electronic device housing and that the feature 8 is formed with a molded mark 85, which is in the form of an H-shaped recess, instead of the interlocking member 81. The molded mark 85 can be selected from a logo, a predetermined pattern, a decorative figure, a slogan, and the like.

With the inclusion of the porous protrusion 6 and the feature 8 molded over the porous protrusion 6 and having the inter locking member(s) 81 or the molded mark(s) 85 in the composite structure 2 of the present invention, at least one of the aforesaid drawbacks associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A composite structure comprising:
a metallic base part made from a metallic material and having at least one bonding region;
at least one porous protrusion made from a sintered metal powder and bonded to and protruding from said bonding region; and
at least one feature molded over said porous protrusion.

2. The composite structure of claim 1, wherein said feature is formed with an interlocking member adapted to interlock with an external component.

3. The composite structure of claim 2, wherein said interlocking member is in the form of a threaded hole formed in said feature.

4. The composite structure of claim 1, wherein said feature is formed with a molded mark.

5. The composite structure of claim 4, wherein said molded mark is selected from a logo, a predetermined pattern, and a decorative figure.

6. The composite structure of claim 1, wherein said metallic material is selected from aluminum, nickel, magnesium, titanium, copper, alloys thereof, and stainless steel.

7. The composite structure of claim 1, wherein said feature is made from a second metallic material or a plastic material selected from thermoplastics, thermosetting resin, elastomer and plastic alloy.

8. A method for making a composite structure, comprising:
preparing a metallic base part made from a metallic material and having at least one bonding region;
applying a body of a metal powder on the bonding region;
laser sintering the body of the metal powder on the bonding region so as to form a porous protrusion of a sintered metal powder bonded to the bonding region; and
molding a moldable material over the porous protrusion of the bonding region so as to form a feature bonded to and covering the porous protrusion.

9. The method of claim 8, further comprising magnetically fixing the body of the metal powder on the bonding region using a magnet during laser sintering of the body of the metal powder.

10. The method of claim 8, wherein the molding of the moldable material over the porous protrusion is conducted by insertion molding.

11. The method of claim, 8, wherein the feature is formed with an interlocking member adapted to interlock with an external component.

12. The method of claim 11, wherein the interlocking member is in the form of a threaded hole formed in the feature.

13. The method of claim 8, wherein the feature is formed with a molded mark.

14. The method of claim 13, wherein the molded mark is selected from a logo, a predetermined pattern, and a decorative figure.

15. The method of claim 8, wherein the metal powder is selected from iron powder, aluminum powder, nickel powder, magnesium powder, titanium powder, copper powder, powders of alloys thereof, and stainless steel powder.
